(19) United States
(12) Patent Application Publication
(10) Pub. No.: US 2020/0300350 A1
(43) Pub. Date: Sep. 24, 2020

(54) CHAIN DRIVE MECHANISM

(71) Applicant: TSUBAKIMOTO CHAIN CO., Osaka (JP)

(72) Inventor: Takahiro Kadono, Osaka-shi (JP)

(73) Assignee: TSUBAKIMOTO CHAIN CO., Osaka (JP)

(21) Appl. No.: 16/808,619

(22) Filed: Mar. 4, 2020

(30) Foreign Application Priority Data
Mar. 22, 2019 (JP) 2019-054509

(51) Int. Cl. F16H 57/00; F16H 55/30

(52) U.S. Cl. CPC F16H 57/0006; F16H 2055/306; F16H 55/30

(57) ABSTRACT

To provide a simple-structured chain drive mechanism that can reduce the noise generated when the chain sits on the sprocket, prevent deterioration of power transmission efficiency, and reduce wear of the sprocket and chain. The chain drive mechanism includes a rotating shaft, a sprocket having a shaft hole, and a chain. The shaft hole is provided with a rotation transmitting groove on an inner circumferential surface thereof. The rotating shaft is provided with a rotation transmitting member that engages with the rotation transmitting groove. The rotation transmitting member is configured to be capable of relative sliding movement at least in a circumferential direction of the rotating shaft and capable of restoring relative positions of the rotating shaft and the sprocket.

### BACKGROUND OF THE INVENTION

### 1. Field of the Invention

The present invention relates to a chain drive mechanism that has a plurality of sprockets and a chain put around the sprockets.

### 2. Description of the Related Art

Chain drive mechanisms that use a plurality of sprockets and a chain such as a roller chain or silent chain put around the sprockets are known and have found use in wide applications such as drive power transmission, synchronized rotation, changing of rpm or torque and so on.

For example, a silent chain is generally made up of a large number of link plates each having a pair of teeth and a pair of pin holes, these link plates being pivotally coupled with connecting pins inserted in the pin holes. The endless silent chain is put around a plurality of sprockets in the chain drive mechanism, the teeth of the link plates meshing with the teeth of the sprockets, so as to transmit rotation.

In such a chain drive mechanism, when each link plate moves onto a sprocket from the free span of the silent chain, teeth of each link plate first abut on the teeth of the sprocket when meshing them, and as the silent chain passes around the sprocket and bends, the link plates sit on the teeth of the sprocket. All of the link plates repeat these actions in cycles at high speed during the rotation, and ways to reduce the noise generated by these meshing and seating actions are being sought after.

For example, a chain drive mechanism (chain and sprocket system) that includes a chain (80) having a plurality of pairs of links (82) coupled together win pins (84), and one or more generally circular sprocket(s) (30, 100) provided on a rotating shaft (cam shaft) and having a plurality of circumferentially spaced teeth (32, 102), with tooth roots (34) for receiving the pins (84) between adjacent teeth (32, 102), is known from Japanese Patent Application Laid-open No. 2003-184996. Each tooth root (34) has a tooth root radius (R2 or R3) that is the distance from the center of the sprocket (30, 100) to a point on the tooth root (34) radially closest to the center of the sprocket (30, 100). At least one of the tooth roots (34) has a second tooth root radius (R2) that is smaller than the first tooth root radius (R3). The system features a particular pattern of arrangement of first and second tooth root radii (R3, R2) effective for redistributing the tension applied on the chain (80) so that the entire tension that acts on the chain (80) during the operation of the system is reduced.

The sprocket (30, 100) of this chain drive mechanism (chain and sprocket system) known from Japanese Patent Application Laid-open No. 2003-184996 has the tooth roots (34) with different root circle radii arranged in a particular pattern of repeated cycles that effectively makes the meshing impact irregular to reduce the noise.

This arrangement can also reduce the maximum tension of the chain as compared to a sprocket having a pattern of arrangement of tooth roots (34) that is random and not a particular pattern of repeated cycles.

An overload protection device is known from Japanese Patent Application Laid-open No. H09-079293, which is provided between a rotating member such as a sprocket or a gear wheel, and a rotating shaft (transmission shaft 2) to which the rotating member is attached, these being used in a chain drive mechanism or the like. A first engaging member 8, a second engaging member 9, and an elastic member (elastic body 10) are assembled between a first key groove 3 provided in an end portion of the rotating shaft (transmission shaft 2), and a rotation transmitting groove (second key groove 7) having substantially the same width as the first key groove 3 and provided in a shaft hole (shaft hole 6) of a boss 5 of the sprocket 4 as the rotating member.

In this overload protection device known from Japanese Patent Application Laid-open No. H09-079293, when the torque transmitted between the sprocket 4 and the rotating shaft (transmission shaft 2) is smaller than a tolerable torque, a convex engaging surface 12 of the second engaging member 9 completely fits in a concave engaging surface 11 of the first engaging member 8 by the biasing force of the elastic member (elastic body 10) so that the rotating shaft (transmission shaft 2) and the sprocket 4 are rotated together. When the torque transmitted between the sprocket 4 and the rotating shaft (transmission shaft 2) exceeds the tolerable torque, the elastic member (elastic body 10) can no longer maintain the engagement between the first engaging member 8 and second engaging member 9 so that the concave engaging surface 11 separates from the convex engaging surface 12 to interrupt the torque transmission.

This configuration stops all the first engaging members 8 and second engaging members 9 from engaging each other again until the rotating shaft (transmission shaft 2) and the rotating member have slipped one turn as an overload torque is applied, so that an overload condition is avoided.

### SUMMARY OF THE INVENTION

However, the chain drive mechanism known from Japanese Patent Application Laid-open No. 2003-184996 still has some scope of improvement.

Namely, the tooth roots of the sprocket vary in root circle radius in the chain drive mechanism known from Japanese Patent Application Laid-open No. 2003-184996 so that there are differences in pitch radius when the silent chain sits on the sprocket, which causes large rotation fluctuations of the chain and could deteriorate power transmission efficiency.

Also, the wear on tooth surfaces tends to progress fast because the meshing between the sprocket and chain and the seating of the chain on the sprocket take place on the same tooth surfaces.

The overload protection device used for a chain drive mechanism and the like and known from Japanese Patent Application Laid-open No. H09-079293 is configured to cause the transmission shaft and the rotating member to slip one turn when an overload torque is applied before they transmit torque again, because of which there was the problem of increased maintenance frequency due to wear caused by the second engaging member sliding on the transmission shaft during the slip.

The present invention solves these problems and it is an object of the invention to provide a simple-structured chain drive mechanism that can reduce the noise generated when the chain sits on the sprocket, minimize rotation fluctuations of the chain to prevent deterioration of power transmission efficiency, and retard the progress of wear of the sprocket and chain.

The present invention solves these problems by providing a chain drive mechanism including a rotating shaft, a sprocket having a shaft hole through which the rotating shaft is passed, and a chain put around the sprocket, the shaft hole being provided with a rotation transmitting groove on an inner circumferential surface thereof, the rotating shaft being provided with a rotation transmitting member that engages with the rotation transmitting groove, and the rotation transmitting member being configured to be capable of relative sliding movement at least in a circumferential direction of the rotating shaft and capable of restoring relative positions of the rotating shaft and the sprocket.

According to one aspect of the present invention, the shaft hole is provided with a rotation transmitting groove on an inner circumferential surface thereof, the rotating shaft is provided with a rotation transmitting member that engages with the rotation transmitting groove, and the rotation transmitting member is configured to be capable of relative sliding movement at least in a circumferential direction of the rotating shaft and capable of restoring relative positions of the rotating shaft and the sprocket. As the sprocket and the rotating shaft slightly displace in the circumferential direction, the timing of contact between the sprocket teeth and the chain can be made random, whereby the order noises caused by meshing can be reduced. Also, the contact points when meshing and seating can be varied, so that the wear of the sprocket and the chain can be retarded.

As the impact of contact between the sprocket teeth and the chain can be mitigated by the rotating shaft and sprocket slightly displacing in the circumferential direction, the impact noise can be reduced.

Moreover, the tension generated by the sprocket teeth and the chain meshing each other can be absorbed by the rotating shaft and sprocket slightly displacing in the circumferential direction, which prevents the chain drive mechanism from being subjected to an excessive load, so that wear of the sprocket and chain can be retarded even more, making possible a longer service life of the device and a reduction of material costs.

Since the sprocket and the rotating shaft slide on each other only within a range in which the rotation transmitting member expands and contracts in the circumferential direction, wear of the shaft hole and the outer circumferential surface of the rotating shaft can be reduced.

According to another aspect of the present invention, the rotation transmitting member includes an elastic member capable of expanding and contracting in the circumferential direction of the rotating shaft. By changing the material of the elastic member, the circumferential displacement between the sprocket and the rotating shaft can be adjusted appropriately so that the torque transmission efficiency is not compromised.

According to another aspect of the present invention, the rotation transmitting member includes a plurality of elastic members with different hardnesses arranged along the circumferential direction of the rotating shaft. The circumferential displacement between the sprocket and the rotating shaft can be adjusted by the elastic members with different hardnesses to an appropriate amount in accordance with the generated tension so that the torque transmission efficiency is not compromised.

According to another aspect of the present invention, the rotation transmitting member includes a key formed to have a smaller width than the rotation transmitting groove, and an elastic member provided between the rotation transmitting groove and the key and capable of expanding and contracting in a circumferential direction. This allows a general-purpose key, or a general-purpose rotating shaft having an integrally formed key, to be used, so that the production cost can be reduced.

According to another aspect of the present invention, there is provided an elastic member between an inner circumferential surface of the shaft hole and an outer circumferential surface of the rotating shaft, wherein the rotating shaft is passed through the shaft hole such as to be slidable on the shaft hole via the elastic member. Since the sprocket and the rotating shaft do not directly contact with each other, the wear of the shaft hole and the outer circumferential surface of the rotating shaft can be reduced even more.

Since the sprocket and the rotating shaft can displace not only in the circumferential direction but also in the radial direction, the impacts of meshing and seating can be absorbed by the entire elastic member between the shaft hole and the rotating shaft, so that the order noises caused by meshing can be reduced even more consistently, and wear of the sprocket and chain can be retarded.

### BRIEF DESCRIPTION OF THE DRAWINGS

FIG. 1 is a front view illustrating a sprocket 100 and a rotating shaft 110 of a chain drive mechanism according to one embodiment of the present invention;

FIG. 2 is a front view of the sprocket 100 of the chain drive mechanism according to one embodiment of the present invention;

FIG. 3 is a front view of the rotating shaft 110 of the chain drive mechanism according to one embodiment of the present invention;

FIG. 4 is a front view illustrating a condition of the sprocket 100 and rotating shaft 110 of the chain drive mechanism according to one embodiment of the present invention before the rotation transmitting member 120 deforms;

FIG. 5 is an enlarged view of part A illustrating a condition of the sprocket 100 and rotating shaft 110 of the chain drive mechanism according to one embodiment of the present invention before the rotation transmitting member 120 deforms;

FIG. 6 is an enlarged view of part A illustrating a condition of the sprocket 100 and rotating shaft 110 of the chain drive mechanism according to one embodiment of the present invention where the rotation transmitting member 120 has deformed;

FIG. 7 is an enlarged view of part A illustrating a condition of the sprocket 100 and rotating shaft 110 of the chain drive mechanism according to one embodiment of the present invention where the rotation transmitting member 120 is restoring its shape;

FIG. 8 is an enlarged view of part A illustrating a condition of a chain drive mechanism according to another embodiment of the present invention before the rotation transmitting member 220 deforms; and

FIG. 9 is a front view illustrating a condition where a sheet-like elastic member 103 is placed between the sprocket 100 and the rotating shaft 310 of a chain drive mechanism according to another embodiment of the present invention.

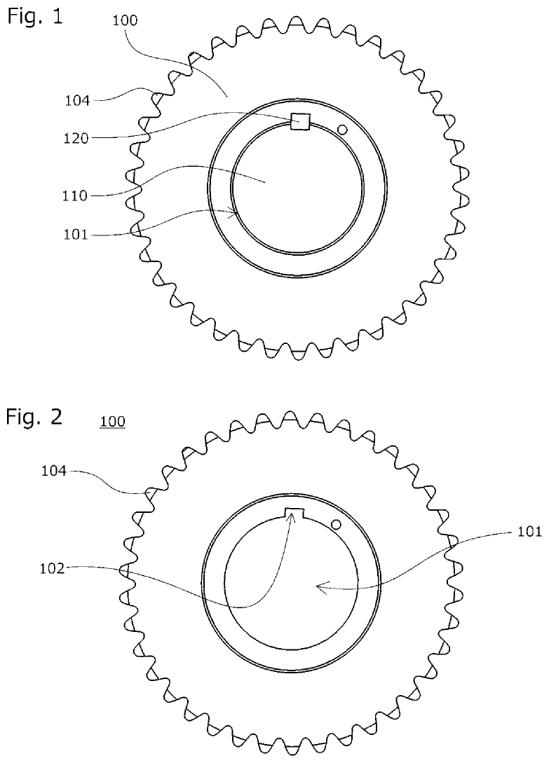

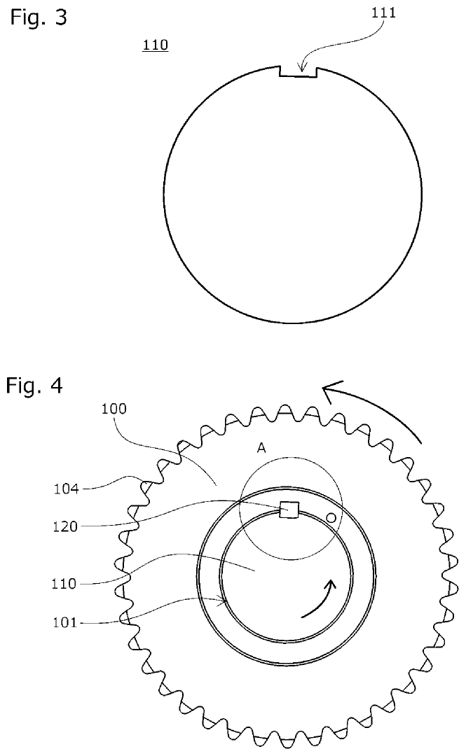

### DESCRIPTION OF THE PREFERRED EMBODIMENTS

A chain drive mechanism according to one embodiment of the present invention will be hereinafter described with reference to the drawings.

The chain drive mechanism that is one embodiment of the present invention includes a rotating shaft 110, a sprocket 100 having a shaft hole 101 which the rotating shaft 110 is passed through, and a chain (not shown) put around the sprocket 100.

A rotation transmitting groove 102 in the form of a slot is formed in an inner circumferential surface of the shaft hole 101 along the direction in which the shaft hole 101 is open.

A receiving groove 111 in the form of a slot along the center axis of the rotating shaft 110 is formed on the outer circumferential surface of the rotating shaft 110. The receiving groove 111 and rotation transmitting groove 102 are formed to have an equal circumferential width.

A rotation transmitting member 120 composed of an elastic member is attached to the receiving groove 111. When the rotating shaft 110 is passed through the shaft hole 101, the receiving groove 111 and the rotation transmitting groove 102 are aligned to face each other, so that an upper part of the rotation transmitting member 120 is passed through the rotation transmitting groove 102.

Thus, the sprocket 100 and rotating shaft 110 are restricted from relative sliding movement in the circumferential direction.

Teeth 104 are formed on the outer circumferential surface of the sprocket 100, for connecting pins (not shown) provided to the chain (not shown) to mesh with and sit on.

The material for the rotation transmitting member 120 is not limited as long as it is an elastic member capable of expanding and contracting in the circumferential direction inside the rotation transmitting groove 102 and receiving groove 111.

Next, how the sprocket 100 and rotating shaft 110 operate when the teeth 104 of the sprocket 100 and the connecting pins (not shown) of the chain (not shown) mesh with each other in the chain drive mechanism according to one embodiment of the present invention will be described with reference to the drawings.

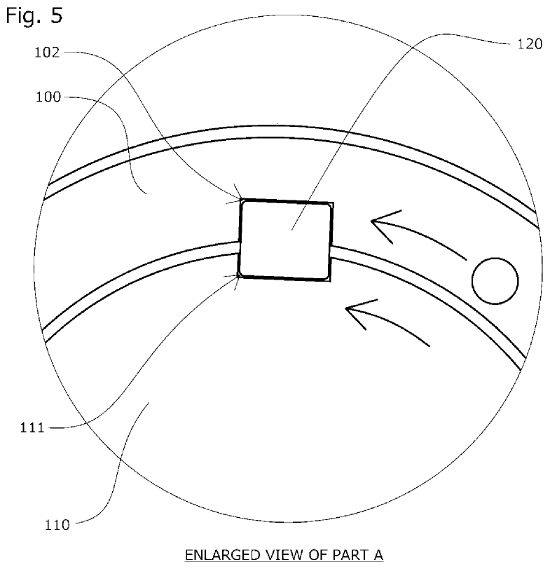

First, when the rotating shaft 110 rotates counterclockwise at constant speed as shown in FIG. 4 and FIG. 5, the torque is transmitted by the rotation transmitting member 120 to the sprocket 100 so that the sprocket 100 rotates counterclockwise, too. The sprocket 100 that has started rotating meshes with a connecting pin (not shown) of the chain (not shown) that is a roller chain at a predetermined meshing position.

The sprocket 100 at this time, as it presses the connecting pin (not shown) in the advancing direction, receives a force opposite from the advancing direction, i.e., in the direction in which it rotates clockwise.

This momentarily reduces the counterclockwise rotation speed of the sprocket 100, resulting in a difference in rotation speed between the sprocket and the rotating shaft 110.

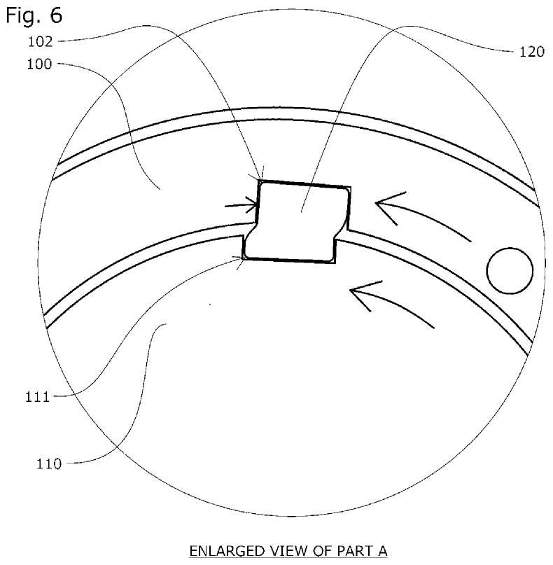

Since the upper part of the rotation transmitting member 120 is passed through the rotation transmitting groove 102 of the sprocket 100 while the lower part is connected to the receiving groove 111 of the rotating shaft 110, the rotation transmitting member 120 deforms as it receives a clockwise force from the sprocket 100 as shown in FIG. 6, causing the sprocket 100 and the rotating shaft 110 to be slightly displaced relative to each other only to the extent that the torque transmission efficiency is not compromised.

This difference in relative positions between the sprocket 100 and the rotating shaft 110 absorbs the impact when the sprocket 100 engages the connecting pin (not shown), or mitigates load torque, and enables reduction of tension, or wear of the teeth 104 of the sprocket 100, as a result of which the device life can be increased.

Since the rotation transmitting member 120 is composed of an elastic member, the deformed rotation transmitting member generates a force to return to its shape before the deformation.

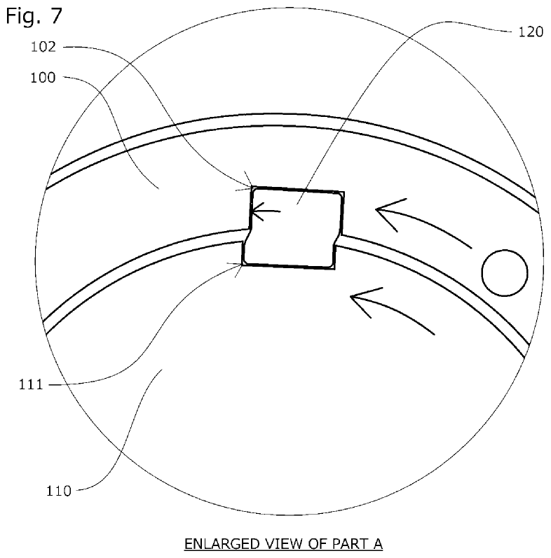

The sprocket 100 at this time receives a counterclockwise force from the rotation transmitting member 120 returning to its original shape as shown in FIG. 7, so that the difference in relative positions between the sprocket 100 and the rotating shaft 110 is gradually removed.

Next, as the chain (not shown) rotate further, the connecting pin (not shown) gradually moves from the predetermined meshing position where it engages with the sprocket 100 to a predetermined seating point.

The rotation transmitting member 120 deforms when the connecting pin (not shown) sits on the sprocket 100, too, as the sprocket 100 contacts the connecting pin (not shown) and receives a force therefrom. As the rotation transmitting member 120 deforms, there is created a slight difference in relative positions between the sprocket 100 and the rotating shaft 110, which absorbs the impact when the connecting pin sits on the sprocket and mitigates the load torque.

Connecting pins (not shown) mesh with and sit on the sprocket 100 continuously and periodically in the chain drive mechanism. For this reason, the order noises that are generated when the connecting pins (not shown) mesh with and sit on the sprocket 100 may sometimes increase. The slight displacement between the sprocket 100 and the rotating shaft 110 that occurs when meshing and seating causes the timing of meshing and seating to shift marginally, which enables reduction of order noises.

The shifted timing of meshing and seating means the abutting position between the connecting pin (not shown) and the teeth 104 also being displaced, which helps retard the wear of the teeth 104 of the sprocket 100 caused by meshing and seating, whereby the service life of the chain drive mechanism can be increased and material costs can be decreased.

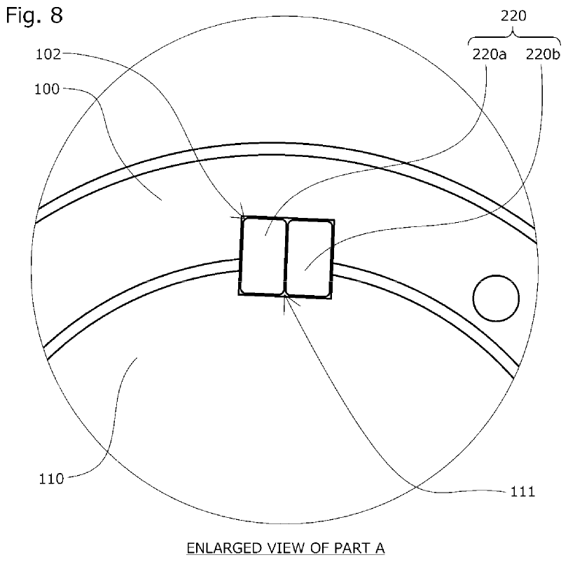

As another embodiment of the present invention, as shown in FIG. 8, a combination of a first elastic member 220a and a second elastic member 220b having different hardnesses may be arranged and used as a rotation transmitting member 220. This way, as the first elastic member 220a and second elastic member 220b deform suitably corresponding to the level of tension that is generated, the circumferential displacement between the sprocket 100 and the rotating shaft 110 can be adjusted to an appropriate amount so that the torque transmission efficiency is not compromised.

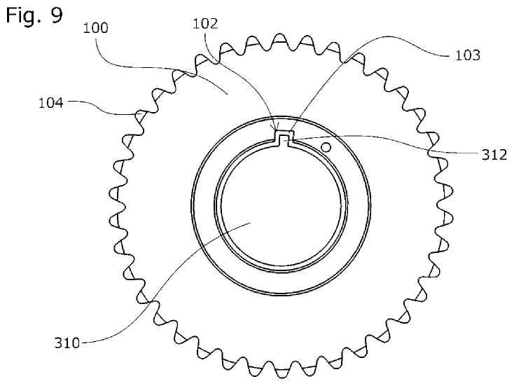

As a further embodiment of the present invention, as shown in FIG. 9, a sheet-like elastic member 103 may be provided between an inner circumferential surface of the shaft hole 101 and an outer circumferential surface of the rotating shaft 310 that has a key 312.

This allows the sprocket 100 and the rotating shaft 310 to displace not only in the circumferential direction but also in the radial direction so that the impacts generated when the connecting pins (not shown) mesh with and sit on the sprocket 100 can be absorbed by the entire sheet-like elastic member 103. Moreover, since the sprocket 100 and the rotating shaft 310 do not directly contact with each other, the wear of the shaft hole 101 and the outer circumferential surface of the rotating shaft 310 can be reduced.

While embodiments of the present invention have been described above in detail, the present invention is not limited to these embodiments and may be carried out with various design changes without departing from the scope of the present invention set forth in the claims.

For example, while the chain was described as a roller chain in the embodiments above, the type of the chain is not limited to this and the chain may be a silent chain, for example.

While the rotating shaft is provided with a receiving groove and a rotation transmitting member composed of an elastic member is attached in the receiving groove in the embodiments described above, the configuration of the rotating shaft is not limited to this. For example, the rotating shaft may have no receiving groove and the rotation transmitting member may be directly attached to the outer circumferential surface of the rotating shaft, or the rotation transmitting member may be attached to both end faces in the circumferential direction of a key that is integrally formed on the rotating shaft.

While the receiving groove and the rotation transmitting groove are formed such that their circumferential widths are equal to each other in the embodiments described above, the relationship between the receiving groove and the rotation transmitting groove is not limited to this. For example, the rotation transmitting groove may be formed wider in the circumferential direction than the receiving groove.

While a first elastic member and a second elastic member having different hardnesses are used in combination as the rotation transmitting member in one embodiment described above, the combination that makes up the rotation transmitting member is not limited to this. Three or more types of elastic members having different hardnesses may be arranged in combination and used as the rotation transmitting member, or a rigid member and an elastic member may be arranged in combination and used as the rotation transmitting member.

While a sheet-like elastic member is provided all around between the inner circumferential surface of the shaft hole and the outer circumferential surface of the rotating shaft provided with a key so that the sprocket and the rotating shaft need not directly contact with each other in one embodiment described above, the arrangement of the elastic member is not limited to this. For example, an elastic member may be arranged in uniformly distributed dots on the inner circumferential surface of the shaft hole to avoid direct contact between the sprocket and the rotating shaft.

What is claimed is:

1. A chain drive mechanism comprising a rotating shaft, a sprocket having a shaft hole through which the rotating shaft is passed, and a chain put around the sprocket,
the shaft hole being provided with a rotation transmitting groove on an inner circumferential surface thereof,
the rotating shaft being provided with a rotation transmitting member that engages with the rotation transmitting groove, and
the rotation transmitting member being configured to be capable of relative sliding movement at least in a circumferential direction of the rotating shaft and capable of restoring relative positions of the rotating shaft and the sprocket.

2. The chain drive mechanism according to claim 1, wherein the rotation transmitting member includes an elastic member capable of expanding and contracting in the circumferential direction of the rotating shaft.

3. The chain drive mechanism according to claim 1, wherein the rotation transmitting member includes a plurality of elastic members with different hardnesses arranged along the circumferential direction of the rotating shaft.

4. The chain drive mechanism according to claim 1, wherein the rotation transmitting member includes a key formed to have a smaller width than the rotation transmitting groove, and an elastic member provided between the rotation transmitting groove and the key and capable of expanding and contracting in a circumferential direction.

5. The chain drive mechanism according to claim 1, further comprising an elastic member provided between an inner circumferential surface of the shaft hole and an outer circumferential surface of the rotating shaft, wherein the rotating shaft is passed through the shaft hole such as to be slidable on the shaft hole via the elastic member.
